(19) United States
(12) Patent Application Publication
(10) Pub. No.: US 2007/0141935 A1
(43) Pub. Date: Jun. 21, 2007

(54) Adjustable light reflecting insect-proof drug belt

(76) Inventor: Yung-Tien Ku, Miaoli Hsien (TW)

Correspondence Address: Yung-Tien Ku, 235 Chung-Ho, Box 8-24, Taipei, TW

(21) Appl. No.: 11/311,709

(22) Filed: Dec. 20, 2005

(51) Int. Cl. B32B 27/04; B32B 27/12; B32B 5/02

(52) U.S. Cl. 442/123

(57) ABSTRACT

The adjustable light reflecting insect-proof drug belt comprises a first belt having an adhering surface at an outer upper side thereof and a cloth surface at an outer lower side thereof; the first belt having a second touch fastener at an inner side thereof; the cloth surface being adhered with at least one insect-proof drug; a second belt being seamed to the cloth surface; a light reflecting sheet adhered to the adhering surface of the first belt to be formed with a receiving surface; an outer side of the second belt being installed with a second touch fastener; the second touch fastener being formed with a hole; a container having earpieces which are seamed to the second belt; and a conduit extended from a lower side of the container; a plurality of holes formed on the conduit; and the conduit passing through the hole of the second belt.

### FIELD OF THE INVENTION

The present invention relates to insect-proof, and in particular to an adjustable light reflecting insect-proof drug belt, wherein the drug is unnecessary to spray out so that the drug necessary is less. Thereby the pollution to air and earth is reduced. Moreover the belt is adjustable by the size of the trunk and the installation of the belt is easy and convenient. Thereby, the damage of insect is reduced. Furthermore, the present invention can be used as an indication in traffic.

### BACKGROUND OF THE INVENTION

In the prior art, inset-killing drugs are sprayed upon the trunks for insect-proof. However the drugs are easily remained on trees, vegetables, or fruits which are difficult to be removed or washed. However the drugs are harmful to human bodies. Furthermore, the drugs will flow into the earth due to rains. For a long time, the drugs will flow to rivers, seas, lakes, etc. However the trees grown from the earth will have the toxicity of the drug. Moreover people will absorb the toxicity from eating. Thus, there is an eager demand to improve the defect in the prior art.

### SUMMARY OF THE INVENTION

Accordingly, the primary object of the present invention is to provide an adjustable light reflecting insect-proof drug belt, wherein the drug is unnecessary to spray out so that the drug necessary is less. Thereby the pollution to air and earth is reduced. Moreover the belt is adjustable by the size of the trunk and the installation of the belt is easy and convenient. Thereby the damage of insect is reduced. Furthermore, the present invention can be used as an indication in traffic.

To achieve above objects, the present invention provides an adjustable light reflecting insect-proof drug belt. The adjustable light reflecting insect-proof drug belt comprises a first belt having an adhering surface at an outer upper side thereof and a cloth surface at an outer lower side thereof; the first belt having a second touch fastener at an inner side thereof; the cloth surface being adhered with at least one insect-proof drug; a second belt being seamed to the cloth surface; a light reflecting sheet adhered to the adhering surface of the first belt to be formed with a receiving surface; an outer side of the second belt being installed with a second touch fastener; the second touch fastener being formed with a hole; a container having earpieces which are seamed to the second belt; and a conduit extended from a lower side of the container; a plurality of holes formed on the conduit which are spaced; the conduit passing through the hole of the second belt so as to be transversally arranged in the receiving space. When insets touch the cloth surface, they eat the drug and die so as to achieve the effect of insect-proof.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a perspective view showing the connection of the first belt and second belt of the present invention.

FIG. 3 is a perspective view showing the seaming of the container to the conduit according to the present invention.

FIG. 4 is a perspective view showing the adhering of the light reflecting sheet.

FIG. 5 is a perspective view showing that the present invention winds around a trunk.

FIG. 6 shows an embodiment about the use of the light reflecting sheet according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

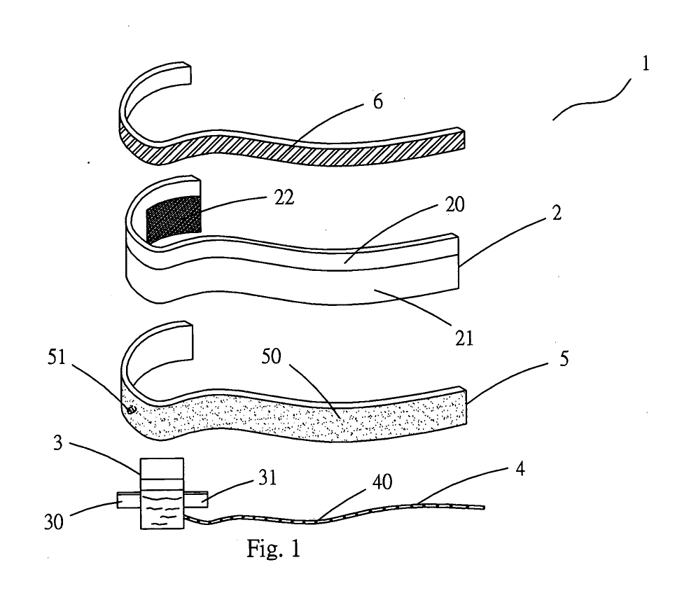

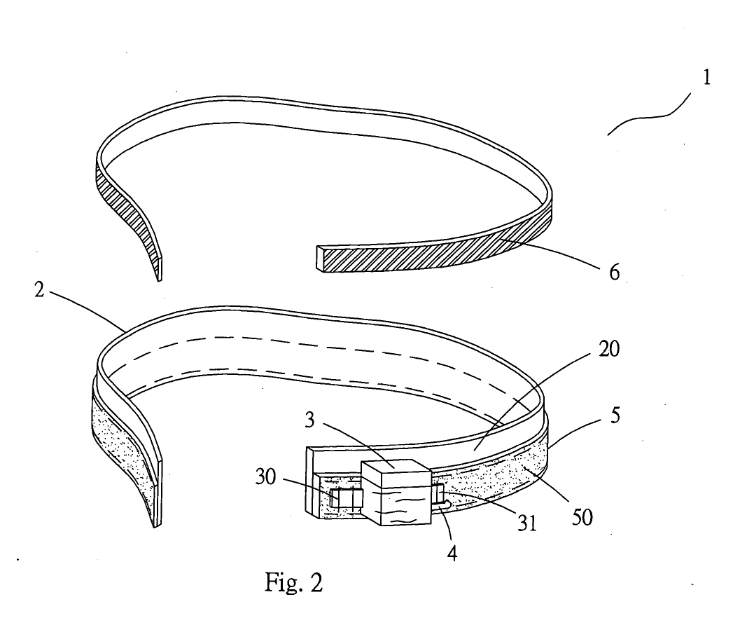

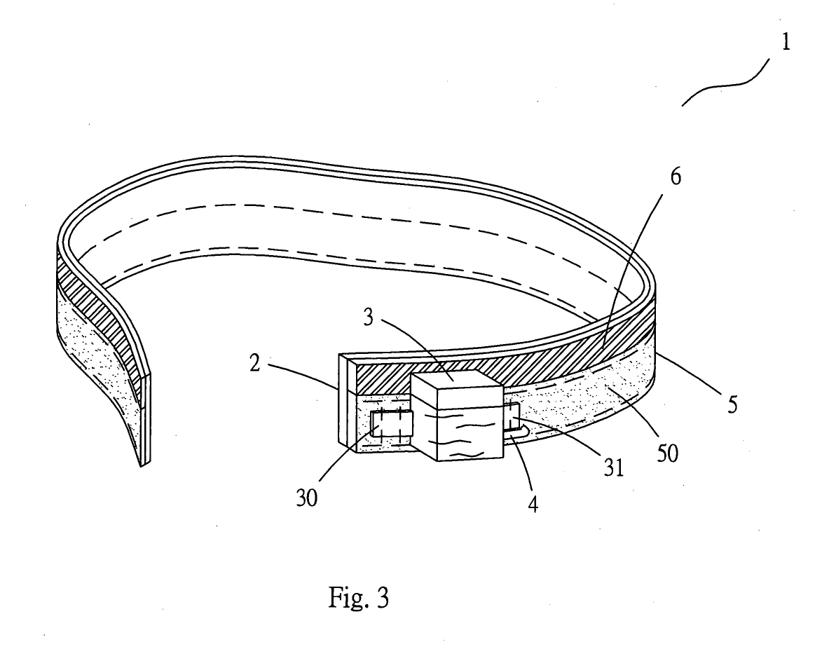

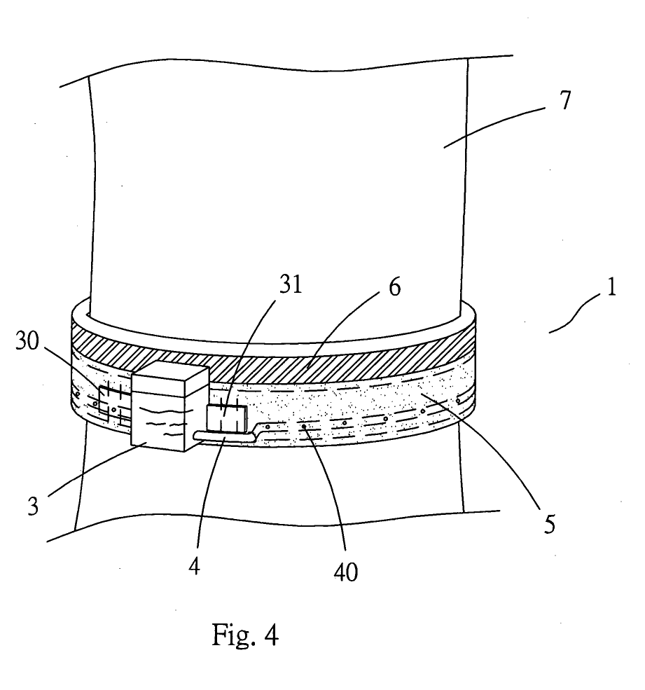

Referring to FIGS. 1 to 4, the adjustable light reflecting insect-proof drug belt of the present invention is illustrated. The adjustable light reflecting insect-proof drug belt has the following elements.

A first belt 2 has an adhering surface 20 at an outer upper side thereof and a cloth surface 21 at an outer lower side thereof. The cloth surface 21. The first belt 2 has a second touch fastener 50 at an inner side thereof. The cloth surface 21 is adhered with insect-proof drug.

A second belt 5 is seamed to the cloth surface 21.

A light reflecting sheet 6 is adhered to the adhering surface 20 of the first belt 2 to be formed with a receiving surface. An outer side of the second belt 5 is installed with a second touch fastener 50. The second touch fastener 50 is formed with a hole 51.

A container 3 has two earpieces 30, 31 which are seamed to the second belt 5.

A conduit 4 extends from a lower side of the container 3. A plurality of holes 40 are formed in the conduit 4 which are spaced apart. The conduit 4 passes through the hole 51 of the second belt 5 so as to be transversally arranged in the receiving space. When the light reflecting insect-proof drug belt 1 is wound as a circle. The first touch fastener 22 is adhered to the second touch fastener 50 so as to wind around a trunk. The size of the circle is adjustable. The adjustment is performed at the adhering position of the first touch fastener 22 and the second touch fastener 50.

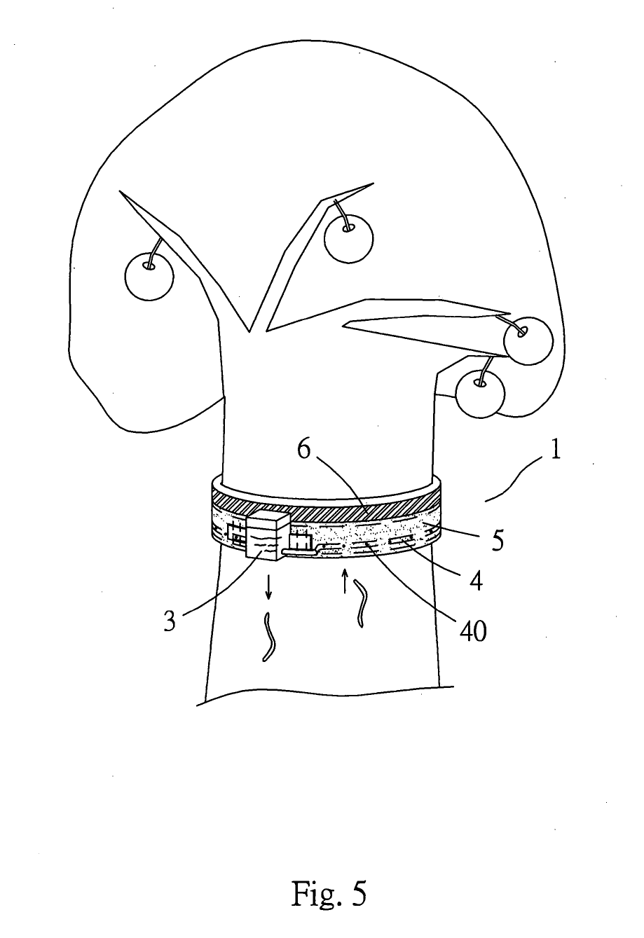

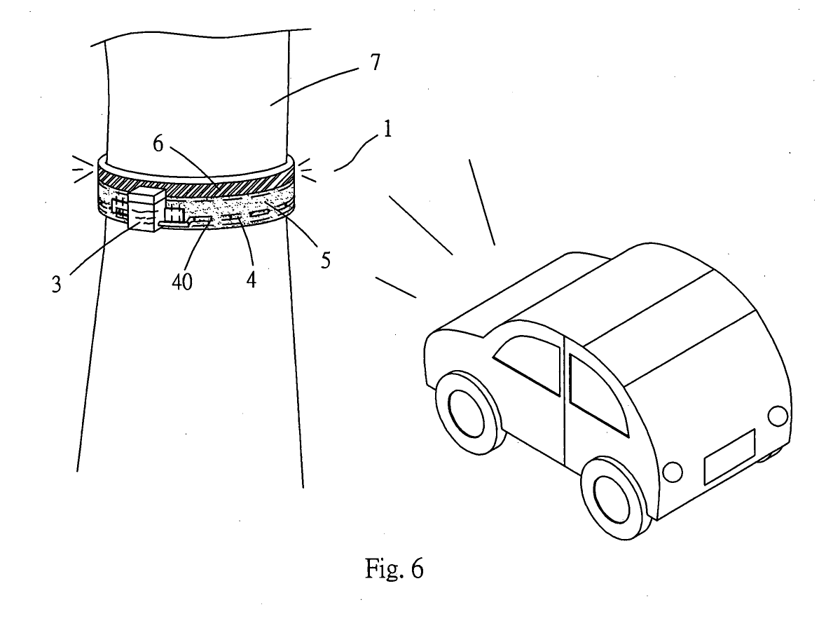

Referring to FIG. 5, when the adjustable light reflecting insect-proof drug belt winds around a trunk 7, if insects go into the cloth surface 21, it will eat the insect-proof drug to die. Referring to FIG. 6, if the adhering surface 20 winds around a trunk 7, the light reflecting sheet 6 has the effect of reflecting light. When a car drives through the trunk 7, the light of the car will be reflected so as to be as an indication.

In the present invention, the drug flows out from the conduit so as to be adhered to the belt. Thereby in one embodiment, the drug is liquid drug.

Advantages of the present invention is that the drug is unnecessary to spray out so that the drug necessary is less. Thereby the pollution to air and earth is reduced. Moreover the belt is adjustable by the size of the trunk and the installation of the belt is easy and convenient. Thereby the destroy of insect is reduced. Furthermore, the present invention can be used as an indication in traffic.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An adjustable light reflecting insect-proof drug belt comprising:
a first belt having an adhering surface at an outer upper side thereof and a cloth surface at an outer lower side thereof; the first belt having a second touch fastener at an inner side thereof; the cloth surface being adhered with at least one insect-proof drug;
a second belt being seamed to the cloth surface;
a light reflecting sheet adhered to the adhering surface of the first belt to be formed with a receiving surface; an outer side of the second belt being installed with a second touch fastener; the second touch fastener being formed with a hole;
a container having earpieces which are seamed to the second belt; and
a conduit extended from a lower side of the container; a plurality of holes formed on the conduit which are spaced apart; the conduit passing through the hole of the second belt so as to be transversally arranged in the receiving space;
wherein when insets touch the cloth surface, they eat the drug and die so as to achieve the effect of insect-proof.

2. The adjustable light reflecting insect-proof drug belt as claimed in claim 1, wherein when the light reflecting insect-proof drug belt is wound as a circle; the first touch fastener is adhered to the second touch fastener so as to wind around a trunk; the size of the circle is adjustable.

3. The adjustable light reflecting insect-proof drug belt as claimed in claim 1, wherein the light reflecting sheet has the effect of reflecting light from a car so as to be as an indication in traffic.
